(19) United States
(12) Patent Application Publication
(10) Pub. No.: US 2012/0192514 A1
(43) Pub. Date: Aug. 2, 2012

(54) TELECOM TOWER VERTICAL AXIS WIND TURBINES

(75) Inventors: Daniel Farb, Beit Shemesh (IL); Joe Van Zwaren, Beit Shemesh (IL); Avner Farkash, Beit Shemesh (IL); Ken Kolman, Beit Shemesh (IL)

(73) Assignee: LEVIATHAN ENERGY WIND LOTUS LTD., Beit Shemesh (IL)

(21) Appl. No.: 13/383,419

(22) PCT Filed: Jun. 21, 2010
(86) PCT No.: PCT/IB10/52782

§ 371 Date: Mar. 19, 2012

Related U.S. Application Data
(60) Provisional application No. 61/224,925, filed on Jul. 13, 2009.

(51) Int. Cl. F03D 9/00; F24J 2/52; E04H 12/00

(52) U.S. Cl. 52/173.3; 52/651.01

(57) ABSTRACT

Attaching wind turbines to towers built for many uses is highly advantageous. The ways of doing that in novel uses and ways are presented.

### FIELD AND BACKGROUND OF THE INVENTION

The present invention relates to a wind turbine built on a tower. There is a need for renewable energy for many reasons, and towers, which can expose turbines to higher velocity winds, are excellent structures for putting on turbines. The kind of turbine and its parameters are important. Providing renewable energy to telecom towers is often necessary because they may be located far from a grid. Since wind speed and hence power output increases with height, a solution is to place wind turbines on the cell tower itself. One problem of telecom towers, for example, is that they need to provide power even when the wind is slow. The current application solves that problem in several ways. One is to provide airfoils or flow deflectors that attach to the structure and accelerate the wind into the blades. Another is to provide solar panels simultaneously on the tower. Even better is to place the solar panels in such a way that they deflect the wind at higher velocity into the blades. (The criterion for a solar panel to act as a flow deflector in this circumstance is that its placement results in an acceleration of wind and increased power output in the turbine.)

Wind turbines are often put on towers. The present application refers to any tower except for one that has a wind turbine only at the top. A connection to the top is obviously prior art. The innovative point here is to use the tower itself below that point as a support structure for wind turbines between the ground and the top. A typical use would be on a telecom tower, where antennae are required for the top, but the middle could be utilized to provide power for the system.

To build such a system, vibration and balance need to be taken into account. That is why the current application emphasizes the use of a vertical axis wind turbine as part of the tower design. That is also why a low level of noise from the turbine is an important part of the design.

Usually, there are two types of towers for telecom or electrical transmission: either a set of beams, or a solid central pole. Solutions for both types are presented here. The pole may also be one that has a vertical axis or other turbine on top; the point of the current patent is that vertical axis turbines be built into the tower itself. In simple words, one is external to the tower, and one is internal. All claims can apply to both types where they are relevant.

There are also various types of underwater towers, sometimes even used for turbines, and this solution could be used with them.

### BRIEF DESCRIPTION OF THE DRAWINGS

The invention is herein described, by way of example only, with reference to the accompanying drawings, wherein:

FIG. 1 is a diagram of a cell or transmission tower with wind turbines.

FIG. 2 is a diagram of a cell or transmission tower with wind turbines extending out.

### DESCRIPTION OF THE PREFERRED EMBODIMENTS

The present invention relates to the placement of vertical axis wind turbines on towers, particularly telecom and electrical towers, but any tower is included, even one which has a turbine on the top, but the turbine on the top is not included.

Definitions: The tower as defined here in the claims is any tower. It may even be a tower to support a turbine, but one of the innovative points is building turbines along the height of the tower. An airfoil is one type of flow deflector. The use of the term “flow deflector” here includes anything that affects the flow into a turbine, and presumably improves its output.

The principles and operation of a wind turbine placed on a tower according to the present invention may be better understood with reference to the drawings and the accompanying description.

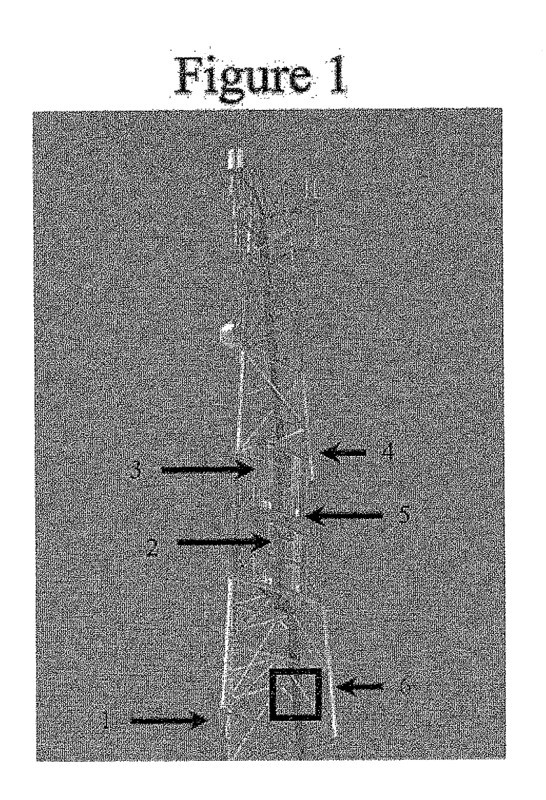

Referring now to the drawings, FIG. 1 illustrates a wind turbine in a cell tower (1), wherein the blades (2, 3) are substantially within the confines of the beams of the tower. Parts (4) and (5) are flow deflectors or foils that accelerate the wind into the blades. Both the foils and the support structures of the turbine shaft are attached to the beams. In one embodiment, the blades are those of a vertical axis turbine. In one embodiment, the turbine has a tip speed ratio (TSR), a concept known to those skilled in the art of wind turbines, of 4 or less, or 2 or less, thereby causing minimal noise and vibration. This will generally mean a drag type (one that works from the push of the air, not primarily by creating pressure and velocity differentials on each side of a blade) of vertical axis turbine, but not necessarily. A solar panel (6) may be attached to the tower. A unique feature of the present application is the placement of such a panel in order to accelerate the wind into the wind turbine blades. Whether airfoil or solar panel, the uses of flow deflectors on a cell tower is unique.

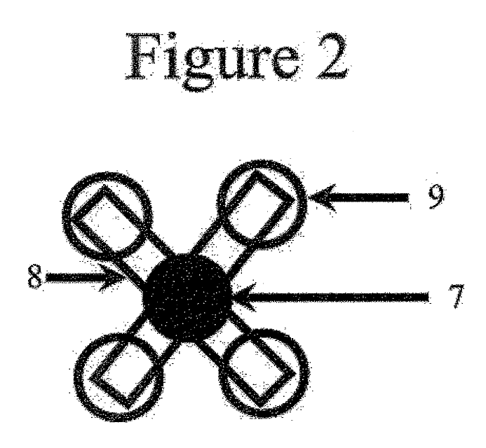

FIG. 2 is a diagram of a cell tower (7) with wind turbines extending out. This is another configuration, wherein the cell tower supports peripheral beams (8), ideally arranged symmetrically around the tower, which hold the turbines (9).

While the invention has been described with respect to a limited number of embodiments, it will be appreciated that many variations, modifications and other applications of the invention may be made.

### SUMMARY OF THE INVENTION

The present invention successfully addresses the shortcomings of the presently known configurations by providing a wind turbine attached to the middle or bottom of a tower.

According to another embodiment,

It is now disclosed for the first time a tower, comprising:

a. At least one vertical axis turbine, attached to said tower's supporting structure, below the top of the tower or below the attachment to another turbine on the top of the tower.

According to another embodiment, said turbine is located substantially within the confines of the supporting beams.

According to another embodiment, the turbine is underwater.

In one embodiment, the tower further comprises

b. Transverse supports connecting the tower to the turbine.

According to another embodiment, the transverse supports and turbines are substantially symmetrical around the tower.

According to another embodiment, the tower is used for support of a wind turbine.

According to another embodiment, the tower is a telecommunications tower.

According to another embodiment, the tower is a transmission tower.

In one embodiment, the tower further comprises:

b. At least one flow deflector attached to the tower in such a way that the velocity of wind into at least one said turbine is accelerated over that of the wind at that height.

According to another embodiment, the flow deflector is a solar panel.

According to another embodiment, the turbine has a TSR (tip speed ratio) of 4 or less.

According to another embodiment, the turbine has a TSR (tip speed ratio) of 2 or less.

According to another embodiment, the turbine is a primarily drag turbine.

In one embodiment, the tower further comprises:

b. A device providing a source of energy in addition to wind

According to another embodiment, the device is solar.

It is now disclosed for the first time a vertical axis wind turbine, attached to the middle or bottom of a telecom or transmission tower.

What is claimed is:

1. A tower, comprising:
a. At least one vertical axis turbine, attached to said tower's supporting structure, below the top of the tower or below the attachment to another turbine on the top of the tower.

2. The tower of claim 1, wherein said turbine is located substantially within the confines of the supporting beams.

3. The tower of claim 2, wherein the turbine is underwater.

4. The tower of claim 1, further comprising:
b. Transverse supports connecting the tower to the turbine.

5. The tower of claim 4, wherein the transverse supports and turbines are substantially symmetrical around the tower.

6. The tower of claim 1, wherein the tower is used for support of a wind turbine.

7. The tower of claim 1, wherein the tower is a telecommunications tower.

8. The tower of claim 1, wherein the tower is a transmission tower.

9. The tower of claim 1, further comprising:
b. At least one flow deflector attached to the tower in such a way that the velocity of wind into at least one said turbine is accelerated over that of the wind at that height.

10. The tower of claim 9, wherein the flow deflector is a solar panel.

11. The tower of claim 1, wherein the turbine has a TSR (tip speed ratio) of 4 or less.

12. The tower of claim 1, wherein the turbine has a TSR (tip speed ratio) of 2 or less.

13. The tower of claim 1, wherein the turbine is a primarily drag turbine.

14. The tower of claim 1, further comprising:
b. A device providing a source of energy in addition to wind

15. The tower of claim 14, wherein the device is solar.

16. A vertical axis wind turbine, attached to the middle or bottom of a telecom or transmission tower.
